(19) United States
(12) Patent Application Publication
(10) Pub. No.: US 2024/0007908 A1
(43) Pub. Date: Jan. 4, 2024

(54) COMMUNICATIONS DEVICE, INFRASTRUCTURE EQUIPMENT AND METHODS

(71) Applicant: Sony Group Corporation, Tokyo (JP)

(72) Inventors: Yuxin WEI, Basingstoke (GB); Vivek SHARMA, Basingstoke (GB); Hideji WAKABAYASHI, Basingstoke (GB); Yassin Aden AWAD, Basingstoke (GB)

(73) Assignee: Sony Group Corporation, Tokyo (JP)

(21) Appl. No.: 18/039,491

(22) PCT Filed: Dec. 1, 2021
(86) PCT No.: PCT/EP2021/083824

§ 371 Date: May 31, 2023

(30) Foreign Application Priority Data
Jan. 7, 2021 (EP) 21150578.9

(51) Int. Cl. H04W 36/00; H04W 76/27

(52) U.S. Cl. CPC H04W 36/0033; H04W 76/27

(57) ABSTRACT

A method of operating a communications device in a serving cell provided by an infrastructure equipment, the method comprising determining a radio access network (RAN) notification area (RNA) identity associated with a current serving cell, determining a cell identity associated with the serving cell, transmitting to a second communications device an indication of the RNA identity, and transmitting to the second communications device an indication of the cell identity.

### BACKGROUND

### Field

The present disclosure relates to communications devices, infrastructure equipment and methods for the transmission of data in a wireless communications network using relay devices. The present disclosure claims the Paris Convention priority to European patent application number 21150578.9 the contents of which are incorporated herein by reference in their entirety.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Third and fourth generation mobile telecommunication systems, such as those based on the 3GPP defined UMTS and Long Term Evolution (LTE) architecture, are able to support more sophisticated services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, may be expected to increase ever more rapidly.

Future wireless communications networks will be expected to support communications routinely and efficiently with a wider range of devices associated with a wider range of data traffic profiles and types than current systems are optimised to support. For example, it is expected future wireless communications networks will be expected to efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance.

In view of this there is expected to be a desire for future wireless communications networks, for example those which may be referred to as 5G or new radio (NR) system/new radio access technology (RAT) systems 111, as well as future iterations/releases of existing systems, to efficiently support connectivity for a wide range of devices associated with different applications and different characteristic data traffic profiles.

The use of relays has been identified as a suitable technique to reduce power consumption and interference within a cell, and to extend the coverage provided by infrastructure equipment. However, there remains a technical problem of ensuring that devices which obtain services via a relay device are able to operate efficiently.

### SUMMARY

The present disclosure can help address or mitigate at least some of the issues discussed above.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device configured in accordance with example embodiments;

FIG. 4 illustrates an example scenario in which embodiments of the present technique may be employed. A corresponding message sequence chart in which a context is retrieved from a previous serving base station in accordance with embodiments of the present technique is shown in FIG. 5;

FIG. 6 and FIG. 7 illustrate an example in which a communications device obtains service via a first relay in a first cell, and subsequently via a second relay in a second cell, in accordance with embodiments of the present technique;

FIG. 8 illustrates an example scenario in which embodiments of the present technique may be employed. A corresponding message sequence chart in which a remote communications device refrains from initiating an update procedure in accordance with embodiments of the present technique is shown in FIG. 9;

FIG. 10 illustrates an example scenario in which embodiments of the present technique may be employed. A corresponding message sequence chart in which a remote communications device refrains from initiating an update procedure in accordance with embodiments of the present technique is shown in FIG. 11;

FIG. 12 illustrates a message sequence chart in accordance with embodiments of the present technique, in which the relay UE is in inactive mode when it selects a new cell; and

FIG. 13 illustrates a flow diagram for a process which may be carried out by a communications device in accordance with embodiments of the present technique.

### DETAILED DESCRIPTION OF THE EMBODIMENTS

Long Term Evolution Advanced Radio Access Technology (4G)

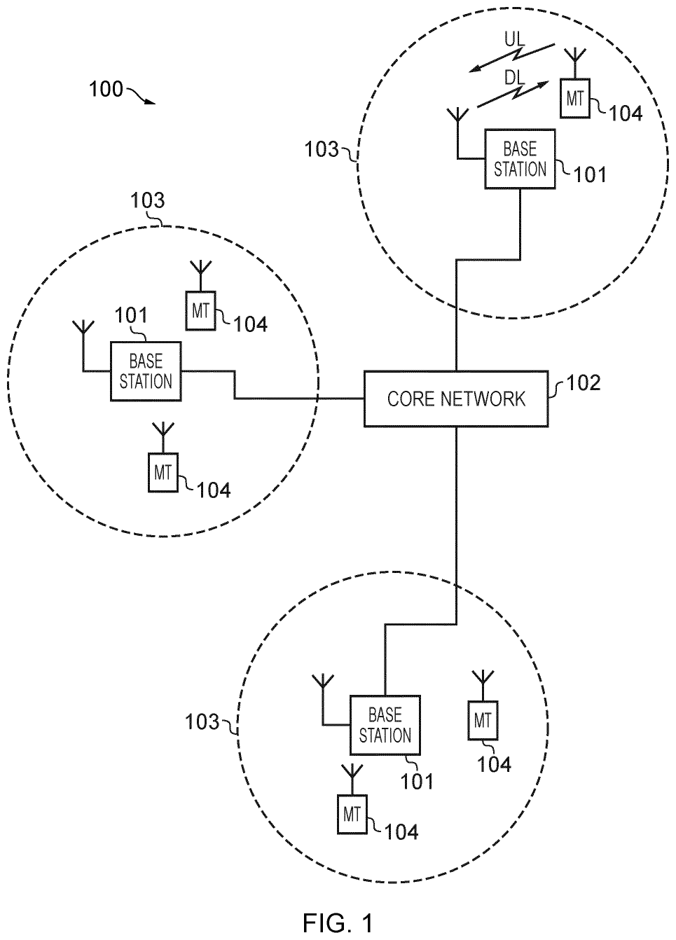

FIG. 1 provides a schematic diagram illustrating some basic functionality of a mobile telecommunications network/system 100 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [2]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 100 includes a plurality of base stations 101 connected to a core network part 102. Each base station provides a coverage area 103 (e.g. a cell) within which data can be communicated to and from communications devices 104. Data is transmitted from the base stations 101 to the communications devices 104 within their respective coverage areas 103 via a radio downlink. Data is transmitted from the communications devices 104 to the base stations 101 via a radio uplink. The core network part 102 routes data to and from the communications devices 104 via the respective base stations 101 and provides functions such as authentication, mobility management, charging and so on. Communications devices may also be referred to as mobile stations, user equipment (UE), user terminals, mobile radios, terminal devices, and so forth. Base stations, which are an example of network infrastructure equipment/network access nodes, may also be referred to as transceiver stations/nodeBs/e-nodeBs, g-nodeBs (gNB) and so forth. In this regard different terminology is often associated with different generations of wireless telecommunications systems for elements providing broadly comparable functionality. However, example embodiments of the disclosure may be equally implemented in different generations of wireless telecommunications systems such as 5G or new radio as explained below, and for simplicity certain terminology may be used regardless of the underlying network architecture. That is to say, the use of a specific term in relation to certain example implementations is not intended to indicate these implementations are limited to a certain generation of network that may be most associated with that particular terminology.

New Radio Access Technology (5G)

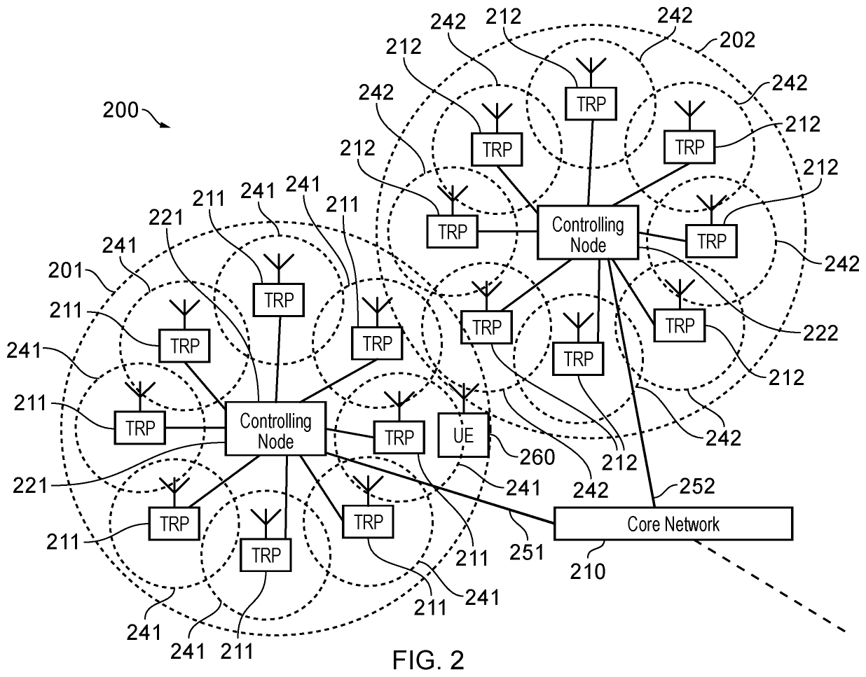

FIG. 2 is a schematic diagram illustrating a network architecture for a new RAT wireless communications network/system 200 based on previously proposed approaches which may also be adapted to provide functionality in accordance with embodiments of the disclosure described herein. The new RAT network 200 represented in FIG. 2 comprises a first communication cell 201 and a second communication cell 202. Each communication cell 201, 202, comprises a controlling node (centralised unit) 221, 222 in communication with a core network component 210 over a respective wired or wireless link 251, 252. The respective controlling nodes 221, 222 are also each in communication with a plurality of distributed units (radio access nodes/remote transmission and reception points (TRPs)) 211, 212 in their respective cells. Again, these communications may be over respective wired or wireless links. The distributed units 211, 212 are responsible for providing the radio access interface for communications devices connected to the network. Each distributed unit 211, 212 has a coverage area (radio access footprint) 241, 242 where the sum of the coverage areas of the distributed units under the control of a controlling node together define the coverage of the respective communication cells 201, 202. Each distributed unit 211, 212 includes transceiver circuitry for transmission and reception of wireless signals and processor circuitry configured to control the respective distributed units 211, 212.

In terms of broad top-level functionality, the core network component 210 of the new RAT communications network represented in FIG. 2 may be broadly considered to correspond with the core network 102 represented in FIG. 1, and the respective controlling nodes 221, 222 and their associated distributed units/TRPs 211, 212 may be broadly considered to provide functionality corresponding to the base stations 101 of FIG. 1. The term network infrastructure equipment/access node may be used to encompass these elements and more conventional base station type elements of wireless communications systems. Depending on the application at hand the responsibility for scheduling transmissions which are scheduled on the radio interface between the respective distributed units and the communications devices may lie with the controlling node/centralised unit and/or the distributed units/TRPs.

A communications device or UE 260 is represented in FIG. 2 within the coverage area of the first communication cell 201. This communications device 260 may thus exchange signalling with the first controlling node 221 in the first communication cell via one of the distributed units 211 associated with the first communication cell 201. In some cases, communications for a given communications device are routed through only one of the distributed units, but it will be appreciated in some other implementations communications associated with a given communications device may be routed through more than one distributed unit, for example in a soft handover scenario and other scenarios.

In the example of FIG. 2, two communication cells 201, 202 and one communications device 260 are shown for simplicity, but it will of course be appreciated that in practice the system may comprise a larger number of communication cells (each supported by a respective controlling node and plurality of distributed units) serving a larger number of communications devices.

It will further be appreciated that FIG. 2 represents merely one example of a proposed architecture for a new RAT communications system in which approaches in accordance with the principles described herein may be adopted, and the functionality disclosed herein may also be applied in respect of wireless communications systems having different architectures.

Thus example embodiments of the disclosure as discussed herein may be implemented in wireless telecommunication systems/networks according to various different architectures, such as the example architectures shown in FIGS. 1 and 2. It will thus be appreciated the specific wireless communications architecture in any given implementation is not of primary significance to the principles described herein. In this regard, example embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 101 as shown in FIG. 1 which is adapted to provide functionality in accordance with the principles described herein, and in other examples the network infrastructure equipment/access node may comprise a control unit/controlling node 221, 222 and/or a TRP 211, 212 of the kind shown in FIG. 2 which is adapted to provide functionality in accordance with the principles described herein.

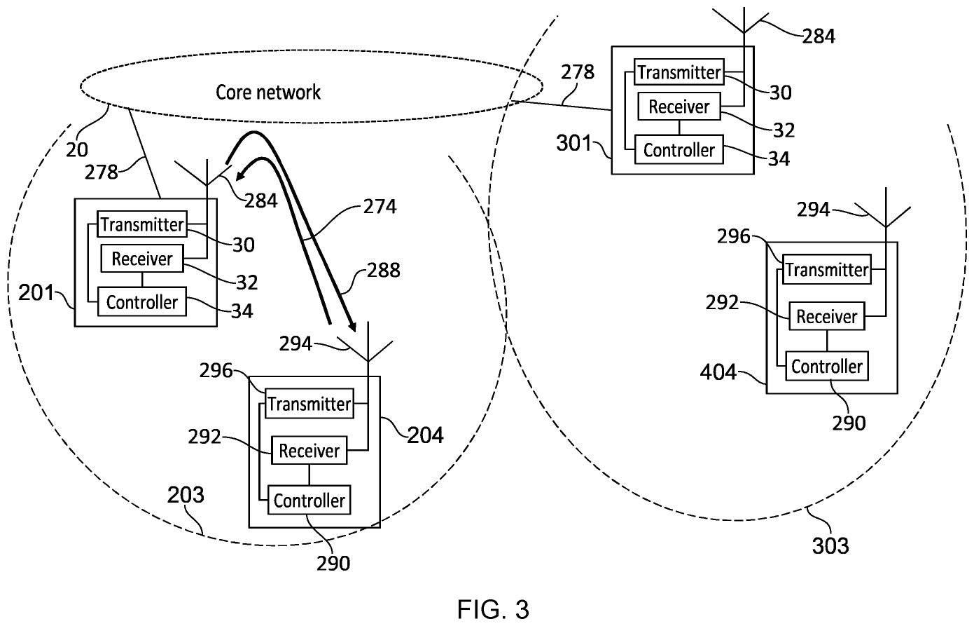

A more detailed illustration of communications devices and example network infrastructure is presented in FIG. 3. FIG. 3 shows a first communications device 204 and a second communications device 404, and example first and second network infrastructure equipment 201, 301, each of which may be thought of as a gNB 101 or a combination of a controlling node 221 and TRP 211. The first and second infrastructure equipment 201, 301 provide respective wireless access interfaces within regions corresponding to first and second cells 203, 303. As shown in FIG. 3, the first communications device 204 is shown within the first cell 203 and transmits uplink data to the first infrastructure equipment 201 using resources an uplink of a wireless access interface as illustrated generally by an arrow 274. The first communications device 204 is shown to receive downlink data transmitted by the first infrastructure equipment 201 via resources of the wireless access interface as illustrated generally by an arrow 288. As with FIGS. 1 and 2, the first and second infrastructure equipment 201, 301 are connected to a core network 20 (which may correspond to the core network 102 of FIG. 1 or the core network 210 of FIG. 2) via interfaces 278 to a controller 34 of each of the first and second infrastructure equipment 201, 301. The first and second infrastructure equipment 201, 301 may additionally be connected to each other, and/or to other similar infrastructure equipment by means of an inter-radio access network node interface, not shown on FIG. 3.

Each of the first and second infrastructure equipment 201, 301 includes a receiver 32 connected to an antenna 284 and a transmitter 30 connected to the antenna 284. Correspondingly, the first communications device 204 includes a controller 290 connected to a receiver 292 which receives signals from an antenna 294 and a transmitter 296 also connected to the antenna 294.

The controller 280 is configured to control the infrastructure equipment 272 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 280 may comprise circuitry which is suitably configured/programmed to provide the desired functionality using conventional programming/configuration techniques for equipment in wireless telecommunications systems. The transmitter 286 and the receiver 282 may comprise signal processing and radio frequency filters, amplifiers and circuitry in accordance with conventional arrangements. The transmitter 286, the receiver 282 and the controller 280 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment 272 will in general comprise various other elements associated with its operating functionality.

Correspondingly, the controller 290 of the first communications device 204 is configured to control the transmitter 296 and the receiver 292 and may comprise processor circuitry which may in turn comprise various sub-units/sub-circuits for providing functionality as explained further herein. These sub-units may be implemented as discrete hardware elements or as appropriately configured functions of the processor circuitry. Thus, the controller 290 may comprise circuitry which is suitably configured/programmed to provide the desired functionality using conventional programming/configuration techniques for equipment in wireless telecommunications systems. Likewise, the transmitter 296 and the receiver 292 may comprise signal processing and radio frequency filters, amplifiers and circuitry in accordance with conventional arrangements. The transmitter 296, receiver 292 and controller 290 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the first communications device 204 will in general comprise various other elements associated with its operating functionality, for example a power source, user interface, and so forth, but these are not shown in FIG. 3 in the interests of simplicity.

The controllers 280, 290 may be configured to carry out instructions which are stored on a computer readable medium, such as a non-volatile memory. The processing steps described herein may be carried out by, for example, a microprocessor in conjunction with a random-access memory, which may be non-volatile memory, operating according to instructions stored on a computer readable medium.

There is also shown in FIG. 3 a second communications device 404, which may comprise an antenna 294, transmitter 296, receiver 292 and controller 290 as in the first communications device 204. In the example of FIG. 3, the second communications device 404 is within the range of the second infrastructure equipment 301. The second communications device 404 is configurable to function as a relay communications device (or relay user equipment, UE). Accordingly, the second communications device 404 may be configurable to provide a sidelink wireless access interface for allowing another communications device to obtain services from an infrastructure equipment, via the relay communications device 404.

Inactive State

Different radio resource control (RRC) states may be defined to provide an appropriate trade-off between a power consumption of a communications device and signalling overhead. For example, in an RRC Idle state, power consumption may be low, but data transmission or reception may not be possible (or may be possible only in respect of a limited quantity of data). For data transmission or reception an RRC Connected state may be used. However, power consumption in this state may be higher.

In accordance with certain conventionally technologies, transitions between RRC idle and RRC connected states required signalling between the radio access network (RAN) (which includes infrastructure equipment, such as the first and second infrastructure equipment 201, 301 of FIG. 3) and the core network (CN). In order to reduce this signalling, while avoiding the need for the communications device to remain in RRC connected state, an RRC inactive state may be used. In the RRC inactive state, the UE is not in an active RRC connected mode with the radio access network (RAN), but is considered to be RRC Connected from a CN (core network) point of view. Accordingly, data can be sent from the core network to the RAN without CN-level paging. Instead, paging may be performed at the RAN level, to cause/trigger the UE to resume an RRC connection, and thereby re-enter the RRC connected mode.

This approach has the benefit of being able to allow the communications device to enter a more power efficient state, while reducing the signalling between the CN and the RAN.

For a given communications device in RRC inactive state, the RAN takes over responsibility for paging the communications device, effectively hiding certain RRC state transitions and mobility from the CN, and the CN therefore may directly send data as if the UE was still in RRC connected and in the same cell, or served by the same infrastructure equipment.

Paging procedures at the RAN level may be associated with a RAN-based notification area (RNA). That is to say, one or more cells associated with the RAN in a network may be notionally grouped into a group corresponding to a RNA. Prior to entering the inactive state, a communications device may be informed of (i.e. configured with) its current RNA. A communications device leaving its RNA, for example as a result of cell reselection, may be configured to inform/update the network of its changing location, by means of an RNA update procedure.

For a communications device in RRC inactive state, an “anchor” base station (e.g. the last base station the communications device was connected to) may be defined. The anchor base station stores context information associated with the communications device. When the CN attempts to transmit data to the communications device, the RAN attempts to page the communications device via the anchor base station. If there is no response, the paging may then be performed on all of the cells in the communications device's RNA, in order to locate the communications device.

Details of the manner in which paging occurs within a given RNA may vary: for example, all cells in an RNA may be paged simultaneously, but these details are not significant here.

The set of cells within an RNA may be specific to a communications device, and may comprise one or more cells. Additionally or alternatively, an RNA may be associated with an identity. Accordingly, a communications device may be configured with an RNA which is defined by a set of cells (and their respective identities) or is defined by an RNA identity.

Further details of an RRC Inactive state and the use of RNAs in the context of a 3GPP 5G (NR) network may be found in [5], the contents of which are incorporated by reference herein.

Relays

A communications device may obtain service within a cell by communicating, using a wireless access interface provided by a base station (or infrastructure equipment) associated with that cell, with that base station. Alternatively, a communications device may communicate with a base station indirectly, by using a relay device (which may be referred to herein as a ‘relay communications device’ or a ‘relay UE’). The relay device may be mobile or stationary. The use of a relay device may reduce the transmission power required for the transmission of data between a base station and the communications device (which may be referred to in such a context as a ‘remote communications device’ or a ‘remote UE’).

In accordance with some proposals, a relay communications device may forward paging messages transmitted in the cell by a base station to a remote communications device. Accordingly, the relay communications device may monitor paging occasions during which the base station may transmit paging message to the remote communications device. These paging messages may be RAN paging messages if the remote communications device is in RRC inactive state.

It is preferable that a communications device is able to use the RRC inactive state irrespective of whether it obtains service directly with a base station or via a relay.

Proposals addressing relays and the use of the RRC inactive state are set out in [3] and [4]. In [3], it is proposed that RAN paging is supported for both remote UEs and relay UEs. It is further proposed that a remote UE shares a same RNA as its associated relay UE. Accordingly, if a relay UE performs an RNA update, then this results in the RNA being updated for all associated remote UEs. However, this imposes a limitation that the RNA of the relay UE must be the same as that of each remote UE.

In [4] it is proposed that the RNA of the relay UE may be configured independently of the RNA of a remote UE. It is further proposed that “a remote UE initiates a RAN area update procedure when reselecting/connecting to a relay that is connected to a cell outside of its configured RAN area”. However, this may result in a significant increase in signalling associated with update procedures.

Accordingly, there is a need in particular to ensure that RAN paging is possible in an efficient and flexible manner for communications devices which obtain service via a relay.

According to embodiments of the present technique, there is provided a method of operating a communications device in a serving cell provided by an infrastructure equipment, the method comprising determining a radio access network (RAN) notification area (RNA) identity associated with a current serving cell, determining a cell identity associated with the serving cell, transmitting to a second communications device an indication of the RNA identity, and transmitting to the second communications device an indication of the cell identity.

Accordingly, a remote communications device which is obtaining relay functionality via another communications device may determine whether an RNA update is required. In some embodiments, based on the received indication, the remote communications device may determine, while in an inactive state, to refrain from performing an RNA update, thus reducing the amount of signalling required for a communications device which is in the inactive state and which obtains relay functionality from another communications device.

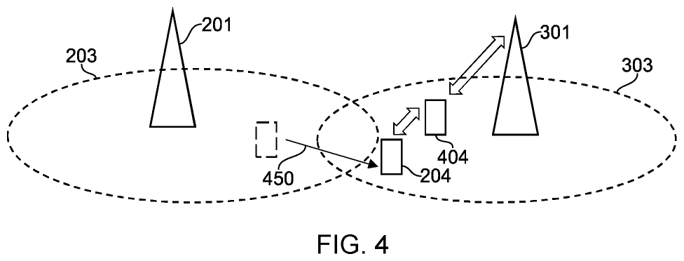

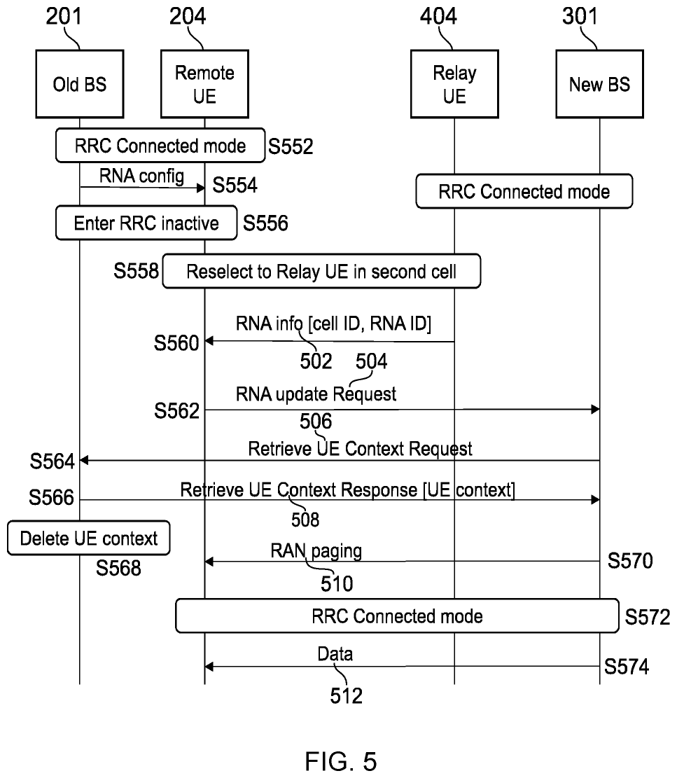

FIG. 4 illustrates an example scenario in which embodiments of the present technique may be employed. A corresponding message sequence chart is shown in FIG. 5.

In the example of FIG. 4 and FIG. 5, the first base station 201 provides a wireless access interface for the first cell 203. The second base station 301 provides a wireless access interface for communications devices in the second cell 303. The first communications device 204 is initially in the first cell 203 (indicated by the dashed outline in FIG. 4) and is in connected mode (step S552).

At step S554, while the first communications device 204 is in the connected mode, the first base station 201 transmits an RNA configuration indication to the first communications device 204. The RNA configuration indicates an RNA. The RNA may comprise one or more cells, and includes the first cell 203. The RNA may be indicated by means of one or more cell identities, or by means of an RNA identity.

Subsequently, at step S556, the first communications device 204 enters the inactive mode.

As indicated by the arrow 450, the first communications device 204 then moves from its initial position to a position within the second cell 303. The first communications device 204 detects the presence of the second communications device 404, and determines that the second communications device 404 provides relay functionality and thus is a relay UE. At step S558, the first communications device 204 selects the relay UE 404. This selection may be in accordance with conventional cell/relay reselection techniques, and may reduce the power consumption associated with subsequent transmission or reception of data to or from the second base station 301 and/or may generally reduce the level of interference within the second cell 303.

In some embodiments, the relay UE 404 is in RRC connected mode in the second cell 303.

In some embodiments, at step S560, the relay UE 404 transmits one or both of an indication of the identity of the second cell 303 (i.e. the cell in which it is obtaining service via the second base station 301) and an indication of an RNA identity associated with an RNA which includes the second cell 303. In the example of FIG. 5, both the cell identity and RNA identity are transmitted within a single RNA info transmission 502, however in some embodiments, they may be sent separately, or only one may be transmitted.

These transmissions may be made by means of one or more of a sidelink (SL) system information block (SIB), a sidelink master information block (SL-MIB) or an on-demand SIB. In some embodiments, these transmissions may be multicast (e.g. to all or a group of the remote UEs which use the relay UE 404 as a relay). In some embodiments these transmissions may be unicast (e.g. using an RRC connection which terminates at the remote UE).

In some embodiments, a remote UE may receive the indication of the identity of the second cell 303 or the indication of the associated RNA identity in a manner which depends on its current state. For example, a remote UE in RRC idle state or RRC inactive state may receive the indication of the second cell and/or the indication of the RNA identity by means of broadcast system information. In another example, a remote UE in RRC connected state may receive the indication of the second cell and/or the indication of the RNA identity by means of a dedicated (unicast) transmission.

In order to allow a communications device which is in RRC inactive state to determine whether it is still within its configured RNA, the communications device may compare the received cell identity or RNA identity with its current (configured) RNA. When the communications device reselects a relay (such as the relay UE 404) the cell identity or RNA identity associated with the UE's current location (i.e. associated with the new cell) may be transmitted by the relay.

In some embodiments, the relay UE 404 may determine the cell identity and/or RNA identity associated with the second cell 303 by receiving an indication (not shown in FIG. 5) of one or both of these transmitted by the second base station 301, for example by means of system information blocks (SIBs) broadcast in the second cell 303.

In the example of FIG. 4 and FIG. 5, the first communications device 204 at step S558 performs a reselection while in the inactive state, and selects the relay UE 404 to provide communications services in the second cell. In accordance with embodiments of the present technique, the relay UE 404 at step S560 transmits an RNA information message comprising an identity of the second cell 303, and an identity of an RNA associated with the second cell 303. Accordingly, the first communications device 204 determines whether it remains located within its configured RNA.

Step S560 may comprise, for example, the periodic or on-demand broadcast of an RNA information message. The RNA information message may be included within another transmission, such as within a relay system information block (SIB) transmission.

If, based on the RNA information 502, the first communications device 204 determines that it is still located within its configured RNA, then in some embodiments, no RNA update procedure is carried out.

If the first communications device 204 determines, based on the RNA information 502, that it is no longer located within its configured RNA, then in some embodiments, the first communications device 204 initiates a RNA update procedure via the relay UE 404.

The RNA update procedure may comprise transmission at step S562 of an RNA update request message 504 to the second base station 301. The RNA update request message 504 may be transmitted via the relay UE 404, that is, the RNA update request message 504 may be transmitted by the first (remote) communications device 404 to the relay UE 404, and may be forwarded by the relay UE 404 to the second (new) base station 301. The RNA update request may comprise an indication of an identity of the first communications device 204 and/or an indication of an identity of the old (first) base station 201 which transmitted the RNA configuration at step S554.

In accordance with embodiments of the present technique, in response to receiving the RNA update request message 504, the second base station 301 transmits at step S564 to the first base station 201 a Retrieve UE context request 506 to obtain a RAN context associated with the communications device 204. The request may be transmitted within an X2AP message.

At step S566, in response to receiving the Retrieve UE context request 506, the first base station 201 transmits a Retrieve UE context response message 508, which includes the RAN context associated with the first communications device 204, to the second base station 301.

At step S568, in response to receiving the Retrieve UE context request 506 (and after transmitting the Retrieve UE context response message 508), the first base station 201 may delete UE context stored at the first base station 201 associated with the communications device 204. Accordingly, the first base station 201 may, for example, treat the first communications device 204 as having entered idle state. The first base station 201 may also notify the core network (not shown) that the first communications device 204 is now reachable via the second base station 301.

Subsequently, downlink data may be transmitted by the core network 20 to the second base station 301, destined for the communications device 204. Because the first communications device 204 is still in the inactive state, the second base station 301 initiates a RAN paging procedure, by transmitting a RAN paging indication 510 to the communications device 204. The RAN paging indication 510 may be relayed via the relay UE 404.

In response to receiving the RAN paging indication 510, the first communications device 204 may enter the connected mode with the second base station 301 (e.g. by performing a random access transmission) at step S572 and may receive the downlink data 512 at step S574.

Accordingly, embodiments of the present technique can permit a communications device to perform reselection to a relay UE while in inactive mode.

In the example of FIG. 4, the first communications device 204 is shown as performing the reselection as a result of physically moving location. However, it will be appreciated that the reselection may be carried out even if there is no motion of the communications device 204. For example, the reselection may be as a result of the relay UE 404 newly becoming available as a relay, or moving closer to the communications device 204, or for any other reason such that predetermined reselection criteria are satisfied.

In the example of FIG. 4 and FIG. 5, the first communications device 204 obtained service in the first cell 203 directly from the first base station 201, and not via a relay. However, in some embodiments, the first communications device 204 obtained service in the first cell 203 via a relay UE.

In some embodiments, the remote (first) communications device 204 is configured to perform periodic RNA updates according to a schedule, even if it remains within its configured RNA. In some such embodiments, if no periodic RNA update request has been received by the first base station 201 and the scheduled time for such a periodic RNA update request has passed, the first base station 201 may delete the UE context associated with the remote communications device 204 and/or consider that the remote communications device 204 has entered the idle state. In the example of FIG. 5, the new relay UE 404 is in connected state when the remote communications device 204 performs the reselection at step S558.

However, in some embodiments, the relay UE 404 may be in the inactive state. Nevertheless, step S560 follows and the remote communications device 204 accordingly determines whether there is a need for an RNA update procedure, based on whether or not the second cell 303 is within the configured RNA of the remote communications device 204.

The remote communications device 204 and the relay UE 404 may establish a connection (such as a PC5 connection) and the relay UE 404 may thus determine that it is responsible for monitoring paging occasions in the second cell which may be used by the second base station 301 for the transmission of paging messages directed to the remote communications device 204. Accordingly, the relay UE 404 may modify its paging monitoring schedule to include these paging occasions. In some embodiments, the paging occasions may be a function of an identity of the remote communications device 204.

Accordingly, as part of the connection establishment, the relay UE 404 may determine the identity of the remote communications device 204, and use this to determine its paging monitoring schedule.

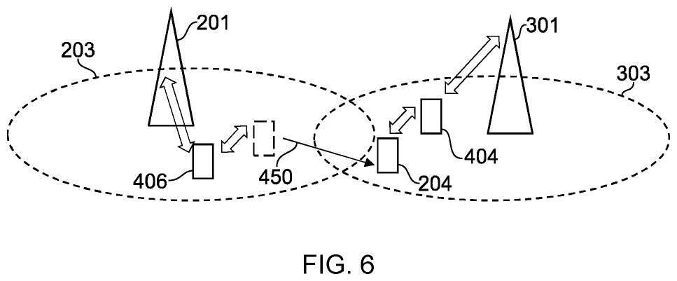

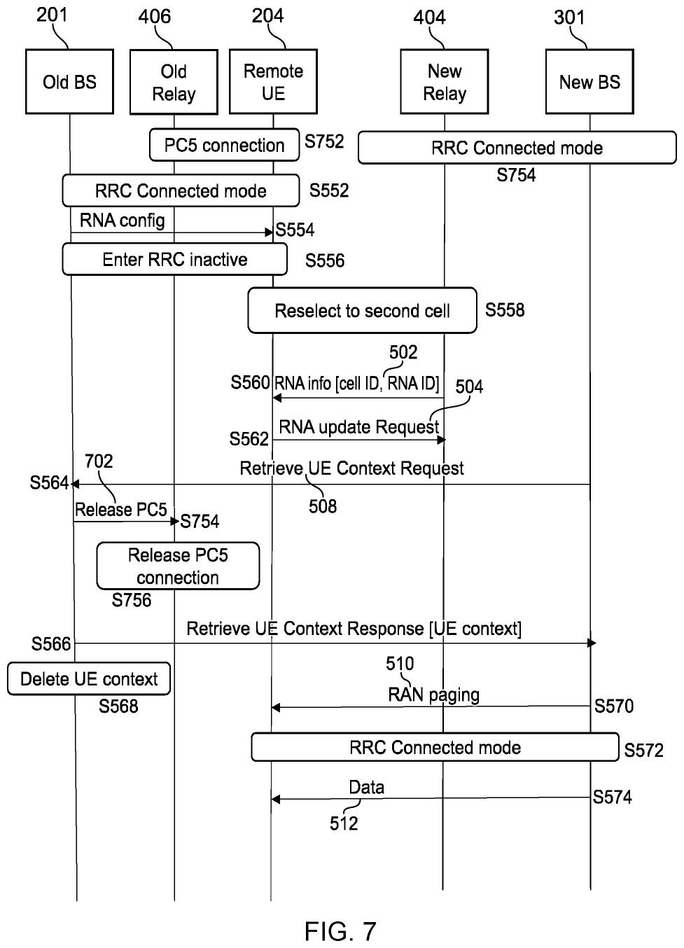

FIG. 6 and FIG. 7 illustrate an example in which a communications device obtains service via a first relay in a first cell, and subsequently via a second relay in a second cell, in accordance with embodiments of the present technique.

Many of the steps and features of the example of FIG. 6 and FIG. 7 are the same as in the example of FIG. 4 and FIG. 5, and like reference numerals are used for these and, for conciseness, their description will be summarised or omitted.

In the example of FIG. 6 and FIG. 7, the first communications device 204 is initially in the first cell 203 and has a sidelink (e.g. PC5) connection 702 established with a first relay UE 406. Accordingly, the first communications device 204 obtains service in the first cell via the first relay UE 406, which is providing relay functionality for the first communications device 204.

The first communications device 204 is in connected mode (step S552), and receives an RNA configuration (step S554). A second (‘new’) relay UE 404 is in RRC connected mode (step S754) with the second (new′) base station 301 in the second cell.

Subsequently, at step S556, the communications device 204 enters inactive mode and at step S558, the communications device 204 selects the new relay UE 404.

Steps S560, S562 and S566 may occur in response to determining, by the first communications device 204, that the new cell (i.e. that in which the new relay UE 404 obtains service from the new base station 301) is not in the RNA indicated at step S554.

In accordance with some embodiments of the present technique, the old base station 201 may transmit a Release PC5 indication 702 to the old (first) relay UE 406, in response to receiving (at step S564) the Retrieve UE Context Request 508. The Release PC5 indication 702 indicates that the first communications device (remote UE) 204 is no longer obtaining service via the old relay UE 406. in response to receiving the Release PC5 indication 702, the old relay 406 may release the sidelink (e.g. PC5) connection at step S756.

In some embodiments, a relay device providing a relay functionality to a remote device monitors paging opportunities in accordance with a schedule of paging opportunities associated with the remote device, whereby paging messages destined for the remote device may be transmitted by the serving base station in accordance with the schedule. In some embodiments, in response to receiving the Release PC5 indication 702, the old relay UE 406 may cease monitoring paging occasions according to the schedule associated with the remote communications device 204 in the first cell.

Steps S568, S570, S572 and S574 may occur, as in the example of FIG. 4 and FIG. 5.

In the examples of FIG. 4, FIG. 5, FIG. 6 and FIG. 7, the communications device 204 performs reselection, as a result of which it obtains service via a new relay, where it had previously obtained service directly from a base station or via a different relay.

In accordance with some embodiments of the present technique, the communications device 204 may leave its presently configured RNA as a result of movement of the relay, from which it is obtaining service.

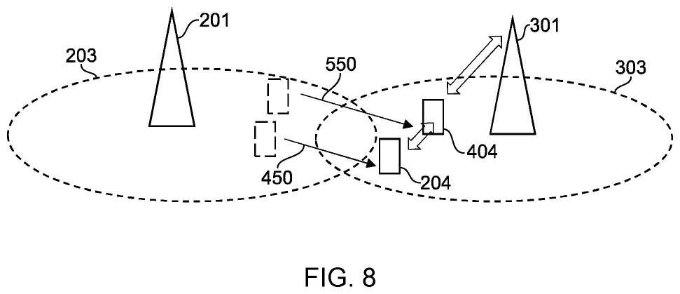

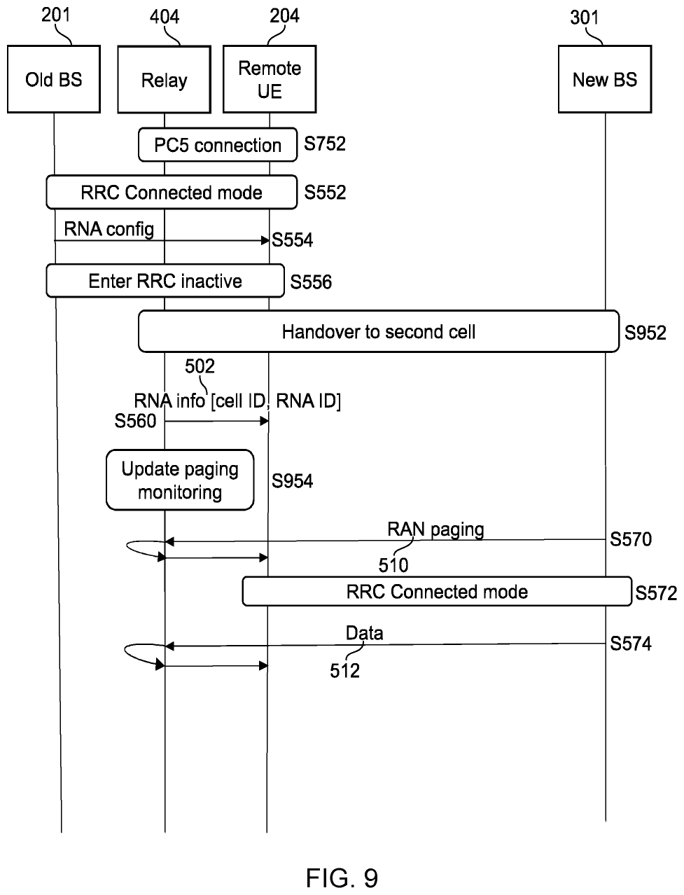

FIG. 8 illustrates an example scenario in which embodiments of the present technique may be employed. A corresponding message sequence chart in accordance with embodiments of the present technique is shown in FIG. 9.

In the example of FIG. 8 and FIG. 9, the communications device 204 initially obtains service from the first base station 201 via a relay 404 in the first cell, as in the example of FIG. 6 and FIG. 7. Accordingly, as a result of steps S752, S552, S554 and S556, the communications device transitions to the inactive state, having obtained its RNA configuration.

The relay device 404 is initially in connected state and has an active RRC connection with the first base station 201. At step S952, the relay device 404 performs handover to the second cell controlled by the second base station 301. The relay device 404 determines (not shown in FIG. 9) the cell ID and RNA ID associated with the second cell and transmits, at step S560, the RNA info 502 to the remote communications device 204.

However, in accordance with embodiments of the present technique, the remote communications device 204 determines that it remains associated with the relay UE 404 and the serving cell of the relay UE is still within the configured RNA of the remote communications device. Accordingly, it refrains from initiating an RNA update procedure.

At step S954, the relay UE 404 determines the schedule of paging occasions associated with the remote communications device 204 in the second cell and modifies its paging monitoring schedule so that it can receive any RAN paging message transmitted in the second cell by the second base station 301 destined for the remote communications device 204. The relay UE 404 may determine the paging occasions which it is required to monitor on behalf of the remote communications device 204 based on an identity of the remote communications device 204, which may have been received by the relay UE 404 at step S752.

Accordingly, when data is received at the old (first) base station 201 for the remote communications device 204, the first base station 201 may initially transmit a RAN paging message in the first cell (not shown in FIG. 9). Simultaneously or subsequently, the first base station 201 may notify other base stations which control cells within the RNA of the remote communications device 204 of the need to page the remote communications device 204. The other base stations include the second base station 301.

Accordingly, at step S570, the second base station 301 transmit RAN paging 510 using a paging occasion associated with the remote communications device 204. This is received by the relay UE 404 and forwarded to the remote communications device 204.

At step S572, in response to receiving the RAN paging 510, the remote communications device 204 enters connected state in the second cell, and at step S574 receives, via the relay UE 404, the data 512.

It will be appreciated that in some embodiments, the manner in which the data 512 is transmitted to the remote communications device 204 may be different. For example, the data might be transmitted without the remote communications device 204 entering the connected state.

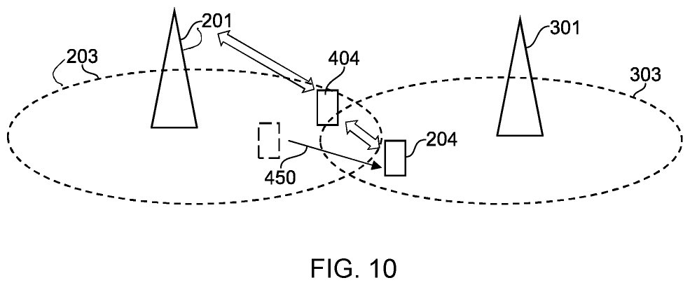

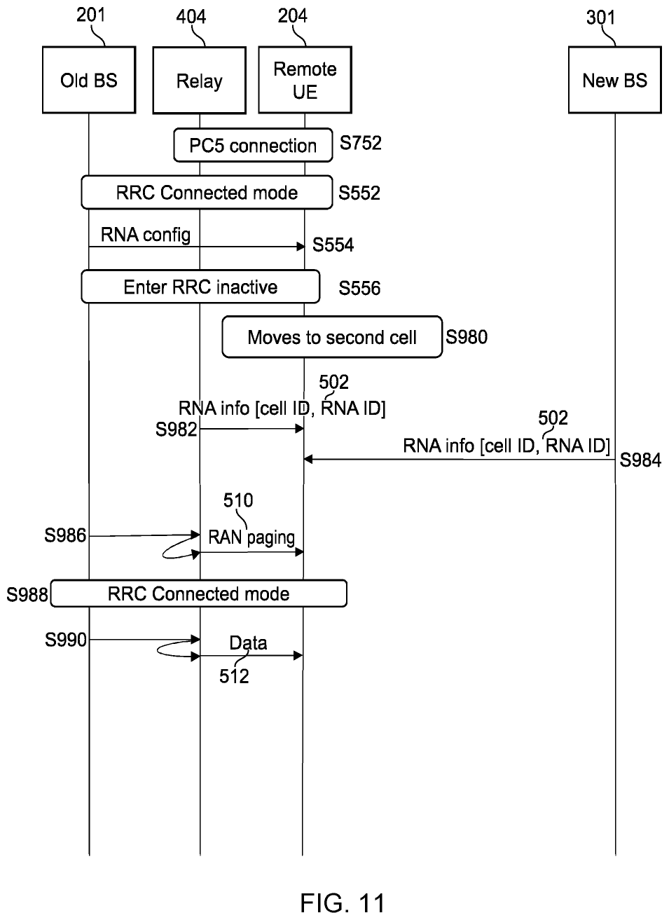

FIG. 10 illustrates an example scenario in which embodiments of the present technique may be employed. A corresponding message sequence chart in accordance with embodiments of the present technique is shown in FIG. 11.

In the example of FIG. 10 and FIG. 11, the communications device 204 initially obtains service from the first base station 201 via a relay 404 in the first cell, as in the example of FIG. 6 and FIG. 7. Accordingly, as a result of steps S752, S552, S554 and S556, the communications device transitions to the inactive state, having obtained its RNA configuration.

The relay device 404 is initially in connected state and has an active RRC connection with the first base station 201. At step S980 the remote UE 204 moves from within the first cell 203 to within the second cell 303, as indicated by the arrow 450 in FIG. 10.

The remote communications device 204 may determine that it is no longer within its configured RNA, based on reception of an indication of an RNA ID and/or cell identity associated with the second cell 303 at step S984.

However, the remote communications device 204 may also maintain its connection with the relay UE 404, which may continue to transmit an indication of the RNA ID and/or cell identity associated with the first cell 203 at step S982.

In accordance with embodiments of the present technique, the remote communications device 204 determines that it remains associated with the relay UE 404 and the relay UE 404 is still within the configured RNA of the remote communications device 204. Accordingly, the remote communications device 204 refrains from initiating an RNA update procedure, even though it may be no longer (physically) within the coverage of a cell which is within its configured RNA and is generated by an infrastructure equipment.

Subsequently, at step S986, the first base station 201 may transmit RAN paging for the remote communications device 204, which is received by the relay UE 404 and forwarded to the remote communications device 204.

At step S990, the first base station 201 may transmit data for the remote communications device 204, which is received by the relay UE 404 and forwarded to the remote communications device 204.

The transmission of the data at step S990 may be preceded by the remote communications device 204 entering the connected state at step S988, in response to receiving the RAN paging.

In the example of FIG. 10 and FIG. 11, the relay UE 404 is shown as remaining within the first cell.

However, in some embodiments, the determination to refrain from initiating an RNA update may be made even if the relay UE 404 moves to a different cell, provided that it remains the case that the relay UE 404 is able to receive RAN paging for the remote communications device 204. This may be be because the relay UE 404 is, in the different cell, still within the RNA configured for the remote communications device 204. In some embodiments, the relay UE 404 may also be in inactive state and the different cell may be also in the configured RNA of the relay UE 404.

In the example of FIG. 8 and FIG. 9, the relay UE 404 is in connected mode when it changes serving cell at step S952.

In some embodiments, the relay UE 404 may be inactive mode when it changes cell.

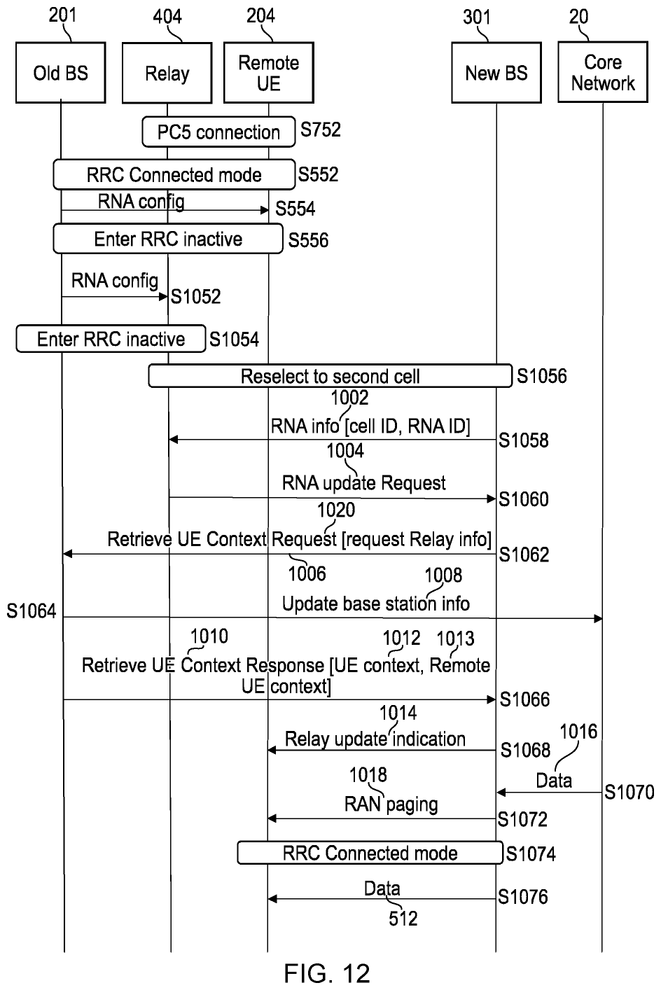

FIG. 12 illustrates a message sequence chart in accordance with embodiments of the present technique, when the relay UE is in inactive mode when it selects the new cell.

In the example of FIG. 12, steps S752, S552, S554 and S556 may occur as in the example of FIG. 9.

In some embodiments, the relay UE 404 is configured at step S1052 with its own RNA by the first base station 201, prior to entering inactive mode at step S1054.

Accordingly, after changing cell to the second cell by reselection at step S1056, the relay UE 404 may perform an RNA update procedure for itself in response to determining that the second cell is not within its configured RNA.

In the example of FIG. 12, at step S1058, the relay UE 404 receives an RNA information indication 1002 which indicates one or both of an RNA identity and a cell identity associated with the second cell, and which is transmitted by the second base station 301.

After step S1058, the relay UE 404 determines that the second cell is not within the RNA configured at step S1052. In response, the relay UE 404 transmits an RNA update Request message 1004 at step S1060 to the second base station 301.

The RNA update request message 1004 may indicate that the relay UE 404 is functioning as a relay UE in respect of one or more remote UEs (such as the remote communications device 204).

In response to receiving the RNA update request 1004, the second base station 301 transmits at step S1062 a Retrieve UE context request 1006 in respect of the relay UE 404. If the base station 301 is aware that the relay UE 404 is in fact functioning as a relay UE, it may explicitly request information regarding remote UEs for which the relay UE 404 was providing relay functionality in the old cell. This request may be, for example, by means of the inclusion of a request relay information indication 1020 in the Retrieve UE context request 1006.

The Retrieve UE context request 1006 is transmitted to the old base station 201.

At step S1064, the old base station 201 may transmit an Update base station info message 1008 to the core network 20. The Update base station info message 1008 may comprise an indication that the relay UE 404 is now reachable via the second base station 301. The Update base station info message 1008 may additionally or alternatively comprise an indication that the remote UE 204 (and any other communications devices for which the relay UE 404 was providing relay functionality in the old cell) is also reachable via the second base station 301.

The Update base station info message 1008 may comprise a message having a format which may also be used in a case where a communications device in inactive state has performed an RNA update with a new base station to indicate that it has left its previously-configured RNA.

The core network 20 may update a stored mapping for the remote communications device 204 and/or the relay UE 404, to indicate that these are now reachable via the second base station 301, and may delete any existing mapping indicating that the remote communications device 204 and/or the relay UE 404 are reachable via the first base station 201.

At step S1066, the old base station 201 may transmit a Retrieve UE context response 1010 to the new base station 301. The Retrieve UE context response 1010 may comprise a UE context 1012 for the relay UE 404. The Retrieve UE context response 1010 may additionally or alternatively comprise a remote UE context indication 1013, indicating the identity of one or more remote UEs for which the relay UE 404 was providing relay functionality in the old (first) cell.

Based on the Retrieve UE context response 1010, the second base station 301 may determine that it can transmit data to the remote communications device 204 via the relay UE 404. Accordingly, at step S1068 the second base station 301 may transmit an indication (such as a Relay update indication 1014) to the remote communications device 204 to indicate that the remote communications device 204 is not required to perform an RNA update, even if the second cell is not within the configured RNA of the remote communications device 204. The indication may be transmitted via the relay UE 404 and/or may be broadcast or included in a paging transmission.

In some embodiments (not shown in FIG. 12), in response to determining that the second base station 301 can transmit data to the remote communications device 204 via the relay UE 404, the second base station 301 may modify the RNA associated with the remote communications device 204 to include the second cell. In some embodiments, this modification may comprise transmitting an indication to the remote communications device 204 to indicate that it should enter connected state. In some embodiments, the indication of the modified RNA may be transmitted using a small data transmission technique, thus avoiding the need for the remote communications device 204 to enter the connected state. In some embodiments, the indication of the modified RNA may be transmitted using a paging message.

In some embodiments, the communications device 204 may determine that it is obtaining relay functionality in the second cell and that the second cell is not within its configured RNA. In some embodiments, if the communications device 204 determines that the base station is aware of the fact that the communications device 204 is obtaining relay functionality from the relay UE 404, then it may refrain from performing an RNA update procedure, the base station being the base station which is controlling the cell in which the relay UE 404 is obtaining service

For example, if the communications device 204 receives the Relay update indication 1014 that indicates that the second base station 301 (which controls the second cell in which the relay UE 404 is obtaining service) is aware of the fact that the communications device 204 is obtaining relay functionality from the relay UE 404, it may refrain from performing an RNA update procedure.

In some embodiments, if the communications device 204 does not receive such an indication (or cannot otherwise make such a determination), the communications device 204 may perform an RNA update procedure, for example in a similar manner to that shown in FIG. 7 and described above.

In the example of FIG. 12, the second base station 301 transmits the relay update indication 1014 to the communications device 204, and accordingly the communications device 204 does not initiate an RNA update procedure, irrespective of whether or not it determines that it is no longer within its configured RNA. As described above, in some embodiments, as a result of receiving the relay update indication 1014, or otherwise, it may determine that its configured RNA is modified so that it is within its (modified) RNA.

Subsequently, at step S1070, data 1016 having as its destination the communications device 204 may be transmitted from the core network to the second base station 301. The second base station 301 may determine that the communications device 204 is in the inactive state and may accordingly transmit a RAN paging indication 1018 at step S1072 to the communications device 204. The RAN paging indication 1018 may be transmitted via the relay UE 404.

At step S1074, in response to receiving the RAN paging indication 1018, the communications device 204 enters the RRC connected mode, and subsequently, at step S1076 the data 1016 is transmitted, via the relay UE 404, to the communications device 204.

In the example of FIG. 12, the update of the core network is triggered by the Update base station information message 1008, which is transmitted by the first base station 201 at step S1064. In some embodiments, the Update base station information message 1008 is transmitted by the second base station 301 after step S1066, in response to receiving the information regarding the remote UEs for which the relay UE 404 is providing relay functionality.

In accordance with embodiments of the present technique, a remote communications device in inactive state may determine, after a cell change, selection of a relay, or change by a current relay of the current relay's serving cell, whether or not it needs to initiate an RNA update.

This determination may be based on receiving an indication of a cell identity or RNA identity associated with a new cell, where the new cell in the one in which a selected (or current) relay obtains service.

In some cases, in accordance with some embodiments, the remote communications device may determine that even though the new cell is not within its currently configured RNA, it does not need to perform an RNA update. This may be because, for example, signalling (which does not involve the remote communications device) may have the effect of ensuring that subsequent RAN paging for the remote communications device is carried out in the new cell. In some embodiments, when remote communications device is served via a same relay in the old and new cells, this signalling may be initiated by the relay. If the relay is in inactive mode when it changes cell, the signalling may comprise a RNA update performed by the relay UE.

In accordance with some embodiments, the remote communications device may determine that the new cell is within its currently configured RNA, and therefore that it does not need to perform an RNA update. As described in examples above, this may be based on receiving an indication of the cell identity and/or

RNA identity of the new cell from the relay when in the new cell.

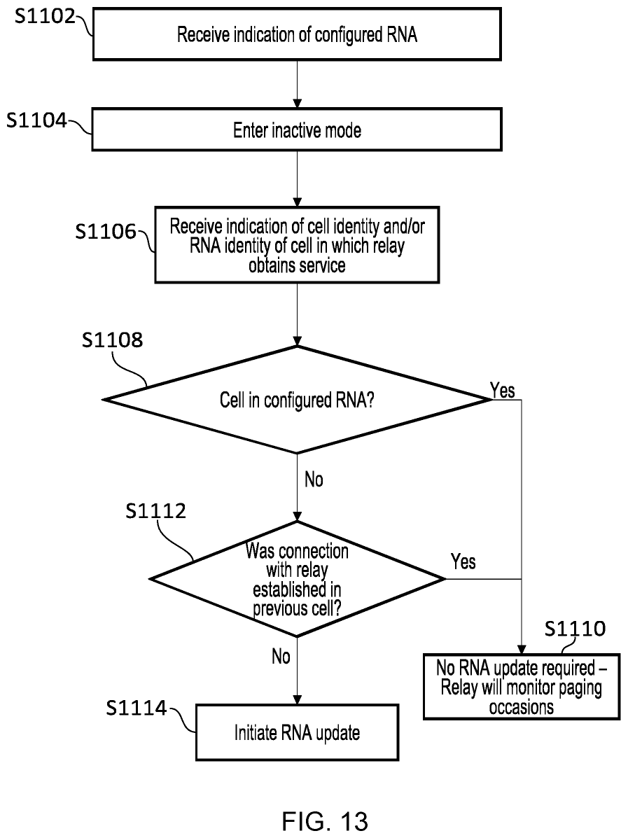

FIG. 13 illustrates a flow diagram for a process which may be carried out by a communications device, such as the remote communications device 204, in accordance with embodiments of the present technique.

The process starts at step S1102, in which the communications device receives an indication of an RNA for use when in inactive state. Step S1102 may occur while the communications device is in connected state. Step S1102 may occur when the communications device is obtaining service via a relay in its serving cell, or is obtaining service directly from an infrastructure equipment.

Subsequently at step S1104, the communications device enters inactive state.

At step S1106, the communications device receives from a relay device, such as the relay UE 404, an indication of a cell identity and/or an RNA identity associated with a cell in which the relay device is obtaining service. The relay device may be newly selected by the communications device, or the communications device may have previously established a sidelink connection with the relay device. Step S1106 may occur after the communications device has newly selected the relay device to provide relay functionality.

At step S1108, the communications device determines, based on the indication(s) received at step S1106, whether the cell in which the relay device is obtaining service is within the RNA configured at step S1102. If it is (‘Yes’), then control passes to step S1110. Otherwise (‘No’) control passes to step S1112.

At step S1110, no RNA update is initiated by the communications device. If not already established, a sidelink may be established with the relay device. The relay device may monitor paging occasions associated with the communications device in the serving cell of the relay device (which may be different from the cell in which the remote communications device is physically located).

At step S1112, the communications device determines whether the relay device provided relay functionality to the communications device in a previous cell. This may be the case, for example, if the communications device and the relay device had established a sidelink connection in a previous cell and step S1106 was triggered by the changing of cell of the relay device, while the sidelink connection was maintained. If so, then control passes to step S1110, and no RNA update is initiated by the communications device. However, the serving base station of the relay device in its new cell may be made aware that the remote communications device is reachable in the new cell as a result of signalling such as a handover procedure or RNA update (or other suitable mobility procedure) of the relay device. Examples of such signalling are described above. In some embodiments, the relay device may initiate a proxy RNA update on behalf of the communications device, even though no signalling may be needed in respect of the relay device itself (e.g. because it is in inactive mode and has remained within its configured RNA). Alternatively, in some embodiments, the remote communications device may determine that the relay is no longer served by a cell which is within the configured RNA of the communications device, and control may pass to step S1114.

If, at step S1112, it is determined that the relay device did not provide relay functionality to the communications device in a previous cell, then control passes to step S1114, and the communications device initiates an RNA update, via the relay device, in the new cell. Accordingly, the serving base station of the relay device in its new cell may be made aware that the communications device is reachable in the new cell.

Following step S1110 or step S1114, RAN paging may be initiated in the new cell to indicate that downlink data is available for transmission to the communications device. The communications device or the relay device may respond to the RAN paging and accordingly the downlink data may be transmitted to the communications device.

Above have been given descriptions of an example process and example message/process sequences. The scope of the present disclosure is not, however, limited to the specific combination and sequence of steps and/or message and in some embodiments, one or more of the steps or messages described may be omitted, or performed in a different manner or order, or otherwise modified. For example, in some embodiments, one or more steps above may be precluded by requirements of a standards specification and may therefore be omitted.

In some embodiments, steps or messages described in the context of one example may be combined with steps or messages described in the context of one or more other examples.

Thus there has been described a method of operating a communications device in a serving cell provided by an infrastructure equipment, the method comprising determining a radio access network (RAN) notification area (RNA) identity associated with a current serving cell, determining a cell identity associated with the serving cell, transmitting to a second communications device an indication of the RNA identity, and transmitting to the second communications device an indication of the cell identity.

There has also been described a method of operating a second communications device, the method comprising receiving in a first cell from an infrastructure equipment of a wireless communications network an indication of a radio access network (RAN) notification area (RNA) within which the second communications device is not required to notify the wireless communications network of a change of cell while in an inactive state, entering the inactive state, receiving from a first communications device an indication of an RNA identity associated with a second cell in which the first communications device is able to provide relay functionality, and receiving from the first communications device an indication of a cell identity associated with the second cell.

There has also been described a method of operating an infrastructure equipment in a wireless communications network, the method comprising transmitting an indication of a configured radio access network (RAN) notification area (RNA) associated with the cell to a communications device via a relay communications device, wherein when in an inactive state the communications device is required to notify an infrastructure equipment of a cell reselection only if a newly selected cell is not within the configured RNA, receiving from a second infrastructure equipment a request for a context associated with the communications device, and in response to receiving the request for the context, transmitting to the relay communications device a sidelink release indication indicating that the relay communications device is no longer providing relay functionality for transmissions between the communications device and the infrastructure equipment.

There has also been described a method of operating a communications device in a serving cell provided by an infrastructure equipment, the method comprising providing a relay functionality for transmissions between a second communications device and the infrastructure equipment in the serving cell, determining that the second communications device is in an inactive state in which the second communications device is required to notify an infrastructure equipment of a cell reselection only if a newly selected cell is not within a configured RNA, receiving from the infrastructure equipment a sidelink release indication indicating that the communications device is no longer providing relay functionality for transmissions between the second communications device and the infrastructure equipment.

There has also been described a method of operating a communications device, the method comprising receiving transmissions in a first cell via a sidelink from a second communications device acting as a relay for the communications device, the transmissions comprising an indication of a radio access network (RAN) notification area (RNA), the first cell being within the RNA, entering an inactive state, in which the communications device is required to notify an infrastructure equipment of a cell reselection only if a newly selected cell is not within the RNA, receiving in a second cell one or more of an indication of an RNA identity and a cell identity associated with the second cell, determining that the serving cell is not within the RNA, and after the determining, and without transmitting an RNA update request message, receiving a RAN paging indication addressed to the communications device.

There has also been described a method of operating an infrastructure equipment in a wireless communications network, the method comprising receiving in a cell an indication from a communications device that a configured radio access network (RAN) notification area (RNA) of the communications device, within which the communications device is not required to notify an infrastructure equipment of a cell reselection, does not include the cell, transmitting a request for a context associated with the communications device to a second infrastructure equipment, and receiving from the second infrastructure equipment the context associated with the communications device and an indication that the communications device is providing relay functionality to a second communications device.

There has also been described a method of operating an infrastructure equipment in a wireless communications network, the method comprising determining that a communications device is providing relay functionality to a second communications device, receiving from another infrastructure equipment a request for a context associated with the communications device, and in response to receiving the request, transmitting to the other infrastructure equipment an indication that the communications device is providing relay functionality to a second communications device.

There has also been described a method of operating an infrastructure equipment in a wireless communications network, the method comprising receiving from a second infrastructure equipment a context associated with a communications device and an indication that the communications device is providing relay functionality to a second communications device. in response to receiving the indication that the communications device is providing relay functionality to the second communications device, transmitting to a core network element a request that data for the second communications device is transmitted to the infrastructure equipment, and transmitting to the second communications device an indication that the second communications device is not required to perform an RNA update procedure.

Corresponding apparatus, circuitry and computer readable media have also been described.

It will be appreciated that while the present disclosure has in some respects focused on implementations in an LTE-based and/or 5G network for the sake of providing specific examples, the same principles can be applied to other wireless telecommunications systems. Thus, even though the terminology used herein is generally the same or similar to that of the LTE and 5G standards, the teachings are not limited to the present versions of LTE and 5G and could apply equally to any appropriate arrangement not based on LTE or 5G and/or compliant with any other future version of an LTE, 5G or other standard.

It may be noted various example approaches discussed herein may rely on information which is predetermined/predefined in the sense of being known by both the base station and the communications device. It will be appreciated such predetermined/predefined information may in general be established, for example, by definition in an operating standard for the wireless telecommunication system, or in previously exchanged signalling between the base station and communications devices, for example in system information signalling, or in association with radio resource control setup signalling, or in information stored in a SIM application. That is to say, the specific manner in which the relevant predefined information is established and shared between the various elements of the wireless telecommunications system is not of primary significance to the principles of operation described herein. It may further be noted various example approaches discussed herein rely on information which is exchanged/communicated between various elements of the wireless telecommunications system and it will be appreciated such communications may in general be made in accordance with conventional techniques, for example in terms of specific signalling protocols and the type of communication channel used, unless the context demands otherwise. That is to say, the specific manner in which the relevant information is exchanged between the various elements of the wireless telecommunications system is not of primary significance to the principles of operation described herein.

It will be appreciated that the principles described herein are not applicable only to certain types of communications device, but can be applied more generally in respect of any types of communications device, for example the approaches can be applied in respect of any type of communications device receiving data.

Further particular and preferred aspects of the present invention are set out in the accompanying independent and dependent claims. It will be appreciated that features of the dependent claims may be combined with features of the independent claims in combinations other than those explicitly set out in the claims.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

Respective features of the present disclosure are defined by the following numbered paragraphs:

Paragraph 1. A method of operating a communications device in a serving cell provided by an infrastructure equipment, the method comprising determining a radio access network (RAN) notification area (RNA) identity associated with a current serving cell, determining a cell identity associated with the serving cell, transmitting to a second communications device an indication of the RNA identity, and transmitting to the second communications device an indication of the cell identity.

Paragraph 2. A method according to paragraph 1, the method comprising providing a relay functionality for transmissions between the second communications device and the infrastructure equipment in the serving cell.

Paragraph 3. A method according to paragraph 1 or paragraph 2, the method comprising receiving from the second communications device an RNA update request message, the RNA update request message indicating that the serving cell is not within a configured RNA of the second communications device, and forwarding the RNA update request message to the infrastructure equipment.

Paragraph 4. A method of operating a second communications device, the method comprising receiving in a first cell from an infrastructure equipment of a wireless communications network an indication of a radio access network (RAN) notification area (RNA) within which the second communications device is not required to notify the wireless communications network of a change of cell while in an inactive state, entering the inactive state, receiving from a first communications device an indication of an RNA identity associated with a second cell in which the first communications device is able to provide relay functionality, and receiving from the first communications device an indication of a cell identity associated with the second cell.

Paragraph 5. A method according to paragraph 4, the method comprising obtaining relay functionality from the first communications device in the second cell.

Paragraph 6. A method according to paragraph 4 or paragraph 5, the method comprising determining, based on one or both of the RNA identity associated with the second cell and the cell identity associated with the second cell, that the second communications device is no longer located within the RNA indicated by the infrastructure equipment.

Paragraph 7. A method according to paragraph 6, the method comprising determining that the second communications device is not required to initiate an RNA update in the second cell.

Paragraph 8. A method according to paragraph 7, wherein determining that the second communications device is not required to initiate an RNA update in the second cell comprises determining that the second communications device was obtaining relay service from the first communications device in the first cell.

Paragraph 9. A method according to paragraph 7 or paragraph 8, the method comprising receiving an indication in the second cell that the radio access network (RAN) notification area (RNA) within which the second communications device is not required to provide a notification to the wireless communications network of a change of cell while in an inactive state includes the second cell.

Paragraph 10. A method according to any of paragraphs 7 to 9, the method comprising receiving a relay update indication in the second cell, indicating that the second communications device is not required to perform an RNA update in the second cell.

Paragraph 11. A method of operating an infrastructure equipment in a wireless communications network, the method comprising transmitting an indication of a configured radio access network (RAN) notification area (RNA) associated with the cell to a communications device via a relay communications device, wherein when in an inactive state the communications device is required to notify an infrastructure equipment of a cell reselection only if a newly selected cell is not within the configured RNA, receiving from a second infrastructure equipment a request for a context associated with the communications device, and in response to receiving the request for the context, transmitting to the relay communications device a sidelink release indication indicating that the relay communications device is no longer providing relay functionality for transmissions between the communications device and the infrastructure equipment.

Paragraph 12. A method according to paragraph 11, the method comprising after transmitting the indication of the configured RNA, determining that the communications device is in the inactive state.

Paragraph 13. A method of operating a communications device in a serving cell provided by an infrastructure equipment, the method comprising providing a relay functionality for transmissions between a second communications device and the infrastructure equipment in the serving cell, determining that the second communications device is in an inactive state in which the second communications device is required to notify an infrastructure equipment of a cell reselection only if a newly selected cell is not within a configured RNA, receiving from the infrastructure equipment a sidelink release indication indicating that the communications device is no longer providing relay functionality for transmissions between the second communications device and the infrastructure equipment.

Paragraph 14. A method according to paragraph 13, the method comprising in response to receiving the sidelink release indication, adjusting a paging occasion monitoring schedule.

Paragraph 15. A method according to paragraph 14, wherein according to the adjusted paging occasion monitoring schedule, the communications device does not monitor paging occasions associated with the second communications device.

Paragraph 16. A method of operating a communications device, the method comprising receiving transmissions in a first cell via a sidelink from a second communications device acting as a relay for the communications device, the transmissions comprising an indication of a radio access network (RAN) notification area (RNA), the first cell being within the RNA, entering an inactive state, in which the communications device is required to notify an infrastructure equipment of a cell reselection only if a newly selected cell is not within the RNA, receiving in a second cell one or more of an indication of an RNA identity and a cell identity associated with the second cell, determining that the serving cell is not within the RNA, and after the determining, and without transmitting an RNA update request message, receiving a RAN paging indication addressed to the communications device.

Paragraph 17. A method according to paragraph 16, wherein the RAN paging indication is received via a relay communications device providing relay functionality to the communications device.

Paragraph 18. A method according to paragraph 17, wherein the relay communications device is the second communications device.

Paragraph 19. A method according to paragraph 18, wherein the second communications device receives the RAN paging indication in the first cell.

Paragraph 20. A method according to any of paragraphs 17 to 19, the method comprising determining that the relay communications device is served by an infrastructure equipment in a cell which is within the RNA.

Paragraph 21. A method according to paragraph 20, the method comprising receiving one or more of an indication of an RNA identity and a cell identity associated with the cell which is within the RNA.

Paragraph 22. A method of operating an infrastructure equipment in a wireless communications network, the method comprising receiving in a cell an indication from a communications device that a configured radio access network (RAN) notification area (RNA) of the communications device, within which the communications device is not required to notify an infrastructure equipment of a cell reselection, does not include the cell, transmitting a request for a context associated with the communications device to a second infrastructure equipment, and receiving from the second infrastructure equipment the context associated with the communications device and an indication that the communications device is providing relay functionality to a second communications device.

Paragraph 23. A method according to paragraph 22, the method comprising in response to receiving the indication that the communications device is providing relay functionality to the second communications device, transmitting to a core network element a request that data for the second communications device is transmitted to the infrastructure equipment.

Paragraph 24. A method according to paragraph 22 or paragraph 23, the method comprising receiving from the second infrastructure equipment a context associated with the second communications device.

Paragraph 25. A method according to any of paragraphs 22 to 24, the method comprising receiving data for transmission to the second communications device, and transmitting a RAN paging notification in the cell indicating that downlink data is available for transmission to the second communications device.

Paragraph 26. A method according to any of paragraphs 22 to 25, the method comprising in response to receiving the indication that the communications device is providing relay functionality to the second communications device, transmitting an indication that a configured RNA of the second communications device includes the cell.

Paragraph 27. A method according to paragraph 26, wherein the indication that the configured RNA of the second communications device includes the cell is transmitted as a small data transmission such that the second communications device does not enter a connected state in order to receive the indication.

Paragraph 28. A method according to paragraph 26, wherein the indication that the configured RNA of the second communications device includes the cell is transmitted in a paging message.

Paragraph 29. A method according to paragraph 26, the method comprising in response to receiving the indication that the communications device is providing relay functionality to the second communications device, transmitting an indication that the second communications device is required to enter a connected state, wherein the indication that the configured RNA of the second communications device includes the cell is transmitted while the second communications device is in the connected state.

Paragraph 30. A method of operating an infrastructure equipment in a wireless communications network, the method comprising determining that a communications device is providing relay functionality to a second communications device, receiving from another infrastructure equipment a request for a context associated with the communications device, and in response to receiving the request, transmitting to the other infrastructure equipment an indication that the communications device is providing relay functionality to a second communications device.

Paragraph 31. A method according to paragraph 30, the method comprising transmitting an indication of a configured radio access network (RAN) notification area (RNA) associated with the cell to the communications device, wherein when in an inactive state the communications device is required to notify an infrastructure equipment of a cell reselection only if a newly selected cell is not within the configured RNA.

Paragraph 32. A method of operating an infrastructure equipment in a wireless communications network, the method comprising receiving from a second infrastructure equipment a context associated with a communications device and an indication that the communications device is providing relay functionality to a second communications device. in response to receiving the indication that the communications device is providing relay functionality to the second communications device, transmitting to a core network element a request that data for the second communications device is transmitted to the infrastructure equipment, and transmitting to the second communications device an indication that the second communications device is not required to perform an RNA update procedure.

Paragraph 33. A method according to paragraph 32, wherein the indication that the second communications device is not required to perform an RNA update procedure is transmitted via broadcast signalling.

Paragraph 34. A method according to paragraph 32, wherein the indication that the second communications device is not required to perform an RNA update procedure is transmitted via paging signalling.

Paragraph 35. A communications device for operating in a wireless communications network, the communications device comprising a transmitter configured to transmit signals on a wireless access interface provided by an infrastructure equipment of the wireless communications network, a receiver configured to receive signals on the wireless access interface, and a controller configured to control the transmitter and the receiver so that the communications device is operable to determine a radio access network (RAN) notification area (RNA) identity associated with a current serving cell, to determine a cell identity associated with the serving cell, to transmit to a second communications device an indication of the RNA identity, and to transmit to the second communications device an indication of the cell identity.

Paragraph 36. Circuitry for a communications device for operating in a wireless communications network, the circuitry comprising transmitter circuitry configured to transmit signals on a wireless access interface provided by an infrastructure equipment of the wireless communications network, receiver circuitry configured to receive signals on the wireless access interface, and controller circuitry configured to control the transmitter circuitry and the receiver circuitry so that the communications device is operable to determine a radio access network (RAN) notification area (RNA) identity associated with a current serving cell, to determine a cell identity associated with the serving cell, to transmit to a second communications device an indication of the RNA identity, and to transmit to the second communications device an indication of the cell identity.

Paragraph 37. A second communications device for operating in a wireless communications network, the second communications device comprising a transmitter configured to transmit signals on a wireless access interface provided by an infrastructure equipment of the wireless communications network, a receiver configured to receive signals on the wireless access interface, and a controller configured to control the transmitter and the receiver so that the second communications device is operable to receive in a first cell from an infrastructure equipment of a wireless communications network an indication of a radio access network (RAN) notification area (RNA) within which the second communications device is not required to notify the wireless communications network of a change of cell while in an inactive state, to enter the inactive state, to receive from a first communications device an indication of an RNA identity associated with a second cell in which the first communications device is able to provide relay functionality, and to receive from the first communications device an indication of a cell identity associated with the second cell.

Paragraph 38. Circuitry for a second communications device for operating in a wireless communications network, the circuitry comprising transmitter circuitry configured to transmit signals on a wireless access interface provided by an infrastructure equipment of the wireless communications network, receiver circuitry configured to receive signals on the wireless access interface, and controller circuitry configured to control the transmitter circuitry and the receiver circuitry so that the second communications device is operable to receive in a first cell from an infrastructure equipment of a wireless communications network an indication of a radio access network (RAN) notification area (RNA) within which the second communications device is not required to notify the wireless communications network of a change of cell while in an inactive state, to enter the inactive state, to receive from a first communications device an indication of an RNA identity associated with a second cell in which the first communications device is able to provide relay functionality, and to receive from the first communications device an indication of a cell identity associated with the second cell.

Paragraph 39. Infrastructure equipment for use in a wireless communications network, the infrastructure equipment providing a wireless access interface, the infrastructure equipment comprising a transmitter configured to transmit signals via the wireless access interface, a receiver configured to receive signals, and a controller configured to control the transmitter and the receiver so that the infrastructure equipment is operable to transmit an indication of a configured radio access network (RAN) notification area (RNA) associated with the cell to a communications device via a relay communications device, wherein when in an inactive state the communications device is required to notify an infrastructure equipment of a cell reselection only if a newly selected cell is not within the configured RNA, to receive from a second infrastructure equipment a request for a context associated with the communications device, and in response to receiving the request for the context, to transmit to the relay communications device a sidelink release indication indicating that the relay communications device is no longer providing relay functionality for transmissions between the communications device and the infrastructure equipment.

Paragraph 40. Circuitry for infrastructure equipment for use in a wireless communications network, the infrastructure equipment providing a wireless access interface, the circuitry comprising transmitter circuitry configured to transmit signals via the wireless access interface, receiver circuitry configured to receive signals, and controller circuitry configured to control the transmitter circuitry and the receiver circuitry so that the infrastructure equipment is operable to transmit an indication of a configured radio access network (RAN) notification area (RNA) associated with the cell to a communications device via a relay communications device, wherein when in an inactive state the communications device is required to notify an infrastructure equipment of a cell reselection only if a newly selected cell is not within the configured RNA, to receive from a second infrastructure equipment a request for a context associated with the communications device, and in response to receiving the request for the context, to transmit to the relay communications device a sidelink release indication indicating that the relay communications device is no longer providing relay functionality for transmissions between the communications device and the infrastructure equipment.

Paragraph 41. A communications device for operating in a wireless communications network, the communications device comprising a transmitter configured to transmit signals on a wireless access interface provided by an infrastructure equipment of the wireless communications network, a receiver configured to receive signals on the wireless access interface, and a controller configured to control the transmitter and the receiver so that the communications device is operable to provide a relay functionality for transmissions between a second communications device and the infrastructure equipment in the serving cell, to determine that the second communications device is in an inactive state in which the second communications device is required to notify an infrastructure equipment of a cell reselection only if a newly selected cell is not within a configured RNA, to receive from the infrastructure equipment a sidelink release indication indicating that the communications device is no longer providing relay functionality for transmissions between the second communications device and the infrastructure equipment.

Paragraph 42. Circuitry for a communications device for operating in a wireless communications network, the circuitry comprising transmitter circuitry configured to transmit signals on a wireless access interface provided by an infrastructure equipment of the wireless communications network, receiver circuitry configured to receive signals on the wireless access interface, and controller circuitry configured to control the transmitter circuitry and the receiver circuitry so that the communications device is operable to provide a relay functionality for transmissions between a second communications device and the infrastructure equipment in the serving cell, to determine that the second communications device is in an inactive state in which the second communications device is required to notify an infrastructure equipment of a cell reselection only if a newly selected cell is not within a configured RNA, to receive from the infrastructure equipment a sidelink release indication indicating that the communications device is no longer providing relay functionality for transmissions between the second communications device and the infrastructure equipment.

Paragraph 43. A communications device for operating in a wireless communications network, the communications device comprising a transmitter configured to transmit signals on a wireless access interface provided by an infrastructure equipment of the wireless communications network, a receiver configured to receive signals on the wireless access interface, and a controller configured to control the transmitter and the receiver so that the communications device is operable to receive transmissions in a first cell via a sidelink from a second communications device acting as a relay for the communications device, the transmissions comprising an indication of a radio access network (RAN) notification area (RNA), the first cell being within the RNA, to enter an inactive state, in which the communications device is required to notify an infrastructure equipment of a cell reselection only if a newly selected cell is not within the RNA, to receive in a second cell one or more of an indication of an RNA identity and a cell identity associated with the second cell, to determine that the serving cell is not within the RNA, and after the determining, and without transmitting an RNA update request message, to receive a RAN paging indication addressed to the communications device.

Paragraph 44. Circuitry for a communications device for operating in a wireless communications network, the circuitry comprising transmitter circuitry configured to transmit signals on a wireless access interface provided by an infrastructure equipment of the wireless communications network, receiver circuitry configured to receive signals on the wireless access interface, and controller circuitry configured to control the transmitter circuitry and the receiver circuitry so that the communications device is operable to receive transmissions in a first cell via a sidelink from a second communications device acting as a relay for the communications device, the transmissions comprising an indication of a radio access network (RAN) notification area (RNA), the first cell being within the RNA, to enter an inactive state, in which the communications device is required to notify an infrastructure equipment of a cell reselection only if a newly selected cell is not within the RNA, to receive in a second cell one or more of an indication of an RNA identity and a cell identity associated with the second cell, to determine that the serving cell is not within the RNA, and after the determining, and without transmitting an RNA update request message, to receive a RAN paging indication addressed to the communications device.

Paragraph 45. Infrastructure equipment for use in a wireless communications network, the infrastructure equipment providing a wireless access interface, the infrastructure equipment comprising a transmitter configured to transmit signals via the wireless access interface, a receiver configured to receive signals, and a controller configured to control the transmitter and the receiver so that the infrastructure equipment is operable to receive in a cell an indication from a communications device that a configured radio access network (RAN) notification area (RNA) of the communications device, within which the communications device is not required to notify an infrastructure equipment of a cell reselection, does not include the cell, to transmit a request for a context associated with the communications device to a second infrastructure equipment, and to receive from the second infrastructure equipment the context associated with the communications device and an indication that the communications device is providing relay functionality to a second communications device.

Paragraph 46. Circuitry for infrastructure equipment for use in a wireless communications network, the infrastructure equipment providing a wireless access interface, the circuitry comprising transmitter circuitry configured to transmit signals via the wireless access interface, receiver circuitry configured to receive signals, and controller circuitry configured to control the transmitter circuitry and the receiver circuitry so that the infrastructure equipment is operable to receive in a cell an indication from a communications device that a configured radio access network (RAN) notification area (RNA) of the communications device, within which the communications device is not required to notify an infrastructure equipment of a cell reselection, does not include the cell, to transmit a request for a context associated with the communications device to a second infrastructure equipment, and to receive from the second infrastructure equipment the context associated with the communications device and an indication that the communications device is providing relay functionality to a second communications device.

Paragraph 47. Infrastructure equipment for use in a wireless communications network, the infrastructure equipment providing a wireless access interface, the infrastructure equipment comprising a transmitter configured to transmit signals via the wireless access interface, a receiver configured to receive signals, and a controller configured to control the transmitter and the receiver so that the infrastructure equipment is operable to determine that a communications device is providing relay functionality to a second communications device, to receive from another infrastructure equipment a request for a context associated with the communications device, and in response to receiving the request, to transmit to the other infrastructure equipment an indication that the communications device is providing relay functionality to a second communications device.

Paragraph 48. Circuitry for infrastructure equipment for use in a wireless communications network, the infrastructure equipment providing a wireless access interface, the circuitry comprising transmitter circuitry configured to transmit signals via the wireless access interface, receiver circuitry configured to receive signals, and controller circuitry configured to control the transmitter circuitry and the receiver circuitry so that the infrastructure equipment is operable to determine that a communications device is providing relay functionality to a second communications device, to receive from another infrastructure equipment a request for a context associated with the communications device, and in response to receiving the request, to transmit to the other infrastructure equipment an indication that the communications device is providing relay functionality to a second communications device.

Paragraph 49. Infrastructure equipment for use in a wireless communications network, the infrastructure equipment providing a wireless access interface, the infrastructure equipment comprising a transmitter configured to transmit signals via the wireless access interface, a receiver configured to receive signals, and a controller configured to control the transmitter and the receiver so that the infrastructure equipment is operable to receive from a second infrastructure equipment a context associated with a communications device and an indication that the communications device is providing relay functionality to a second communications device. in response to receiving the indication that the communications device is providing relay functionality to the second communications device, to transmit to a core network element a request that data for the second communications device is transmitted to the infrastructure equipment, and to transmit to the second communications device an indication that the second communications device is not required to perform an RNA update procedure.

Paragraph 50. Circuitry for infrastructure equipment for use in a wireless communications network, the infrastructure equipment providing a wireless access interface, the circuitry comprising transmitter circuitry configured to transmit signals via the wireless access interface, receiver circuitry configured to receive signals, and controller circuitry configured to control the transmitter circuitry and the receiver circuitry so that the infrastructure equipment is operable to receive from a second infrastructure equipment a context associated with a communications device and an indication that the communications device is providing relay functionality to a second communications device. in response to receiving the indication that the communications device is providing relay functionality to the second communications device, to transmit to a core network element a request that data for the second communications device is transmitted to the infrastructure equipment, and to transmit to the second communications device an indication that the second communications device is not required to perform an RNA update procedure.

Further particular and preferred aspects of the present invention are set out in the accompanying independent and dependent claims. It will be appreciated that features of the dependent claims may be combined with features of the independent claims in combinations other than those explicitly set out in the claims.

### REFERENCES

[1] 3GPP TS 38.300 v. 15.2.0 “NR; NR and NG-RAN Overall Description; Stage 2 (Release 15)”, June 2018
[2] Holma H. and Toskala A, “LTE for UMTS OFDMA and SC-FDMA based radio access”, John Wiley and Sons, 2009
[3] 3GPP Tdoc R2-2009230 “RAN2 impacts introduced by Layer 2 SL relay”, Ericsson, 3GPP TSG-RAN WG2 #112e, 2-13 Nov. 2020
[4] 3GPP Tdoc R2-2009202 “Control Plane Aspects for UE to NW Relays”, InterDigital Inc., 3GPP TSG-RAN WG2 #112e, 2-13 Nov. 2020
[5] 3GPP TS 38.300 “NR; NR and NG-RAN Overall description; Stage-2”, version 16.3.0, October 2020

1. A method of operating a communications device in a serving cell provided by an infrastructure equipment, the method comprising
determining a radio access network (RAN) notification area (RNA) identity associated with a current serving cell,
determining a cell identity associated with the serving cell,
transmitting to a second communications device an indication of the RNA identity, and
transmitting to the second communications device an indication of the cell identity.

2. A method according to claim 1, the method comprising
providing a relay functionality for transmissions between the second communications device and the infrastructure equipment in the serving cell.

3. A method according to claim 1, the method comprising
receiving from the second communications device an RNA update request message, the RNA update request message indicating that the serving cell is not within a configured RNA of the second communications device, and
forwarding the RNA update request message to the infrastructure equipment.

4.-15. (canceled)

16. A method of operating a communications device, the method comprising
receiving transmissions in a first cell via a sidelink from a second communications device acting as a relay for the communications device, the transmissions comprising an indication of a radio access network (RAN) notification area (RNA), the first cell being within the RNA,
entering an inactive state, in which the communications device is required to notify an infrastructure equipment of a cell reselection only if a newly selected cell is not within the RNA,
receiving in a second cell one or more of an indication of an RNA identity and a cell identity associated with the second cell,
determining that the serving cell is not within the RNA, and
after the determining, and without transmitting an RNA update request message, receiving a RAN paging indication addressed to the communications device.

17. A method according to claim 16, wherein the RAN paging indication is received via a relay communications device providing relay functionality to the communications device.

18. A method according to claim 17, wherein the relay communications device is the second communications device.

19. A method according to claim 18, wherein the second communications device receives the RAN paging indication in the first cell.

20. A method according to claim 17, the method comprising
determining that the relay communications device is served by an infrastructure equipment in a cell which is within the RNA.

21. A method according to claim 20, the method comprising
receiving one or more of an indication of an RNA identity and a cell identity associated with the cell which is within the RNA.

22. A method of operating an infrastructure equipment in a wireless communications network, the method comprising
receiving in a cell an indication from a communications device that a configured radio access network (RAN) notification area (RNA) of the communications device, within which the communications device is not required to notify an infrastructure equipment of a cell reselection, does not include the cell,
transmitting a request for a context associated with the communications device to a second infrastructure equipment, and
receiving from the second infrastructure equipment the context associated with the communications device and an indication that the communications device is providing relay functionality to a second communications device.

23. A method according to claim 22, the method comprising
in response to receiving the indication that the communications device is providing relay functionality to the second communications device, transmitting to a core network element a request that data for the second communications device is transmitted to the infrastructure equipment.

24. A method according to claim 22, the method comprising
receiving from the second infrastructure equipment a context associated with the second communications device.

25. A method according to claim 22, the method comprising
receiving data for transmission to the second communications device, and
transmitting a RAN paging notification in the cell indicating that downlink data is available for transmission to the second communications device.

26. A method according to claim 22, the method comprising
in response to receiving the indication that the communications device is providing relay functionality to the second communications device, transmitting an indication that a configured RNA of the second communications device includes the cell.

27. A method according to claim 26, wherein
the indication that the configured RNA of the second communications device includes the cell is transmitted as a small data transmission such that the second communications device does not enter a connected state in order to receive the indication.

28. A method according to claim 26, wherein
the indication that the configured RNA of the second communications device includes the cell is transmitted in a paging message.

29. A method according to claim 26, the method comprising
in response to receiving the indication that the communications device is providing relay functionality to the second communications device, transmitting an indication that the second communications device is required to enter a connected state, wherein
the indication that the configured RNA of the second communications device includes the cell is transmitted while the second communications device is in the connected state.

30.-50. (canceled)
